(19) United States
(12) Patent Application Publication
(10) Pub. No.: US 2019/0070617 A1
(43) Pub. Date: Mar. 7, 2019

(54) NOZZLE FOR SPRAYING AN INORGANIC MASS

(71) Applicant: Refractory Intellectual Property GmbH & Co. KG, Wien (AT)

(72) Inventors: Matthaus Haider, Wien (AT); Michael Klikovich, Hinterbrühl (AT)

(21) Appl. No.: 16/080,299

(22) PCT Filed: Apr. 4, 2016
(86) PCT No.: PCT/EP2016/057301

§ 371 Date: Aug. 27, 2018

(51) Int. Cl. B05B 1/04; B05B 7/14; C21B 7/06; F27D 1/16

(52) U.S. Cl. CPC B05B 1/044; F27D 1/1636; C21B 7/06; B05B 7/1481

(57) ABSTRACT

The invention pertains to a nozzle for spraying and inorganic mass with the following characteristics: a flow channel (10) that extends from a first end (12) with an essentially circular cross section to a second end (14) with an essentially slot-like cross section. The respective minimum cross section of the flow channel (10) changes from a circular to a reniform and ultimately to a slot-like cross section between the first end (12) and the second end (14), and the flow channel extends between the first end (12) and the second end (14) in such a way that an axis (x) extending perpendicular to the circular cross section on the first end (12) and through its center of area is spaced apart from the center of area of at least 50% of the reniform cross sections of the flow channel (10).

The invention pertains to a nozzle for spraying an inorganic mass. In this context, the term inorganic mass particularly includes ceramic masses, especially refractory masses/monolithics with such a consistency (viscosity) that they can be continuously atomized (sprayed) with a nozzle.

Such refractory masses are used, for example, for lining the interior of industrial units that are subjected to high thermal loads (frequently >1000° C.). These include
industrial kilns like rotary kilns for producing cement clinker
industrial furnaces such as shaft kilns for calcining limestone
industrial vessels for accommodating metal melts and/or for treating metal melts such as, for example, converters, electric arc furnaces or ladles.

These masses can be processed with different technologies. The invention concerns a method for spraying/atomizing a mass under pressure with the aid of a nozzle.

The mass cures after it was atomized with the nozzle. To this end, the mass frequently contains a corresponding binder such as cement or a chemical binder, for example a phosphate-based binder.

The prior art and the invention are disclosed below with reference to an example, in which the mass is used for producing a new monolithic wall coating of a metallurgical ladle; however, the invention is not limited in this respect and is also suitable for other applications such as, for example, refinishing damaged (worn out) wall surfaces or repairing refractory coatings.

The majority of nozzles used in prior art have a cylindrical flow channel for the mass, i.e. a flow channel of circular cross section. Such a nozzle has the following disadvantages:
inferior mixing of the mass in the nozzle
small and usually circular impact area
significant rebound (on the surface to be coated), i.e. reduced spraying efficiency; only part of the mass can be used as coating
uneven layer thickness of the sprayed coating.

EP 771863B1 discloses nozzles with multiple outlet openings for spraying refractory masses. This nozzle has a complicated constructive design and does not eliminate the aforementioned disadvantages.

U.S. Pat. No. 3,423,029 proposes to transport the mass along a nozzle that features multiple nozzle tubes on its end on the outlet side, wherein said nozzle tubes are arranged adjacent to one another and feature a circular internal cross section. Consequently, a disadvantageous “branched” flow channel for the mass is formed within the nozzle.

It is an object of the invention, to fluidically optimize a spray nozzle of the above-described type in such a way that an inorganic mass, particularly a refractory mass, can be easily and safely sprayed with high quality in order to thereby produce a homogenous coating with largely constant layer thickness.

The invention is based on the following considerations:
The nozzle should eject a wide, approximately rectangular (and not rotationally symmetrical) fan jet rather than one or more cylindrical (rotationally symmetrical) spray jets, i.e. some kind of a “spray curtain” should be produced. Due to the linear (rather than punctiform) fan jet, the coated surface can be produced in a simpler and more uniform fashion.

This spray curtain makes it possible to spray a relatively large (wall) surface in one single go and the thickness of the thus produced coating is uniform.
The mass should be guided in different directions in a restricted fashion on its way through the nozzle. This is achieved in that the flow channel within the nozzle has different cross sections between a first end (mass intake opening into the nozzle) and a second end (at which the mass is ejected from the nozzle).

In this way, optimized mixing of the mass is achieved along its way through the nozzle and deposits are prevented. The mass is ejected from the nozzle in the form of a homogenous viscous mixture.

The following effects are thereby achieved:
The spraying time is reduced because more mass can be transported through the nozzle without thereby generating greater rebound. This increases the efficiency.
Depending on their design, the output of conventional nozzles of the described type lies, for example, between 70 and 200 kg/min. The inventive nozzle makes it possible to approximately double this output (with the same nozzle cross section on the second end).
The spraying technique is simplified; automatic spraying by means of a robot is also possible.
Superior mixing of the mass to be sprayed and a fluid (such as water) is achieved in the nozzle due to the special/restricted material guidance.

In its most general embodiment, the invention relates to a nozzle for spraying an inorganic mass, which nozzle includes the following features:
a flow channel that extends from
a first end with an essentially circular cross section to
a second end with an essentially slot-like cross section,
the respective minimal cross section of the flow channel changes from a circular to a reniform (kidney shape) and ultimately to a slot-like cross section between the first end and the second end, wherein
each reniform cross section features at least one concavely and one convexly curved peripheral segment.

In the context of the invention, a “circular cross section of the flow channel” refers to an essentially round cross section, i.e. certain tolerances, for example, caused by the manufacture of the nozzle are accepted. Starting from the first end, the circular cross section extends over a certain length of the flow channel, for example 5-10% of the overall length L.

The “minimal cross section” of the flow channel takes into consideration that the flow channel also features curved segments. Consequently, only the smallest cross section is respectively considered in any center of area along the flow channel. In other words: the planes of section for determining the minimal cross section of the flow channel at different locations differ accordingly and may be oriented from vertical to horizontal.

A “reniform cross section of the flow channel” firstly only means that the cross section features at least one concave and at least one convex edge segment. Based on a circular cross section, “reniform” further means that the cross section features an “indentation” (the concave segment), i.e. it is pressed inwardly, at least at one location. This indentation (the concave segment) can be realized by shaping the wall of the flow channel accordingly or by means of a correspondingly installed element. In this case, the basic shape may be round or oval or define a segment of a circle.

In one embodiment, the reniform (kidney shaped) cross sections are characterized by just one concave and just one convex circumferential segment, wherein the curvature radii of both segments may vary along the flow channel.

“Reniform” includes geometries, in which two diagonals (DG1, DG2) that extend perpendicular to one another, differ significantly, particularly DG1/DG2>1.5 or >3. In this case, the reniform cross sections may also extend over a certain length of the flow channel, for example 20-80% of the overall length.

For example, the concave and convex segments respectively extend over an angle of more than 30 degrees referred to the center of area of the corresponding cross section. According to one variation, the convex segment extends over an angle of more than 210 degrees.

The reniform cross sections may feature a circumferential segment, the average curvature radius of which is smaller than twice the diameter of the circular cross section on the first end of the flow channel.

A “slot-like cross section of the flow channel” describes a shape, in which the width B of the flow channel is significantly greater than the height H extending perpendicular thereto, particularly B/H>3, >5 or >7. The slot may be rectangular, particularly on the narrow sides, but also rounded. The large boundary surfaces preferably extend parallel and linear in order to produce a defined fan jet of the ejected mass. The slot-like region likewise extends over a certain length in the flow direction of the mass, for example 5-25% of the overall length.

According to an embodiment, the flow channel extends between the first end and the second end in such a way that an axis, extending perpendicular to the circular cross section at the first end and through its center of area is spaced apart from the center of area of at least 30% of the reniform cross sections of the flow channel.

The absolute overall length L of the nozzle in the flow direction of the mass typically is 20-70 cm.

In other words: the cross section of the flow channel changes from the first end to the second end. For example, a first segment has a length of less than 0.35 L and is largely round (circular), a central segment has a length of 0.2-0.8 L and a reniform cross section, and a third segment (end segment) has a length of less than 0.45 L and a slot-like cross section with parallel, planar large sides, wherein the different cross sections transform into one another continuously (without steps).

On its way through the nozzle, the mass is forcibly pushed outward, particularly due to the “concave zones” of the reniform cross sections, such that the mixing effect is intensified. This is described in greater detail below with reference to figures.

The basic design of the nozzle can be varied with one or more of the following characteristics:
The cross sections of the flow channel between the first end and the second end have an identical area, wherein “identical area” also includes tolerances up to 5%. This prevents dead zones in the flow channel.
The cross sections of the flow channel between the first end and the second end deviate by no more than 30% and particularly become smaller toward the nozzle outlet, i.e. the respective (minimal) cross-sectional area becomes smaller toward the second end. According to an embodiment, the cross section decreases by no more than 20%, but usually <10%, and preferably by no more than 5%. In this way, the flow speed is increased without the risk of a blockage.
According to an embodiment, the axis extending perpendicular to the circular cross section at the first end and through its center of area may also extend through the center of area of the slot-like cross section of the flow channel at the second end and perpendicular to this cross section. In other words: the axial flow direction of the mass is (vectorially) identical at the intake and at the end of the nozzle; however, the flow direction changes (vectorially) along the flow channel.
Another embodiment is characterized in that the vectorial flow direction differs at the first and at the second nozzle end. For example, the flow channel is curved or angled in the last segment (toward the nozzle end) and extends, e.g., at an angle of <45 degrees to the axial flow direction at the first end of the nozzle.
According to a variation, the aforementioned axis extends perpendicular to the circular cross section on the first end and through its center of area, but outside the slot-like cross section of the flow channel on the second end.

In other words: the nozzle has a flow channel that extends oblique (at an angle) to the aforementioned axis on the first end of the nozzle. This geometry is advantageous with respect to a uniform mass transport through the nozzle without bubbling.
A fluidically advantageous embodiment is realized as described below: the flow channel extends in an arched fashion at least along one segment between the first end and the second end, i.e. the flow channel has at least one segment, in which the principal flow direction of the mass is not linear, but rather curved/arched, namely first in one direction and then in another direction. This geometry is advantageous with respect to a uniform mass transport through the nozzle without bubbling (flow shadow) and may be combined with the above-described embodiments. The arch typically has the following dimensions: the shortest distance between the aforementioned axis (extending perpendicular to the circular cross section and through the center of area at the nozzle intake) and the center of area of the arched segment, which lies farthest away from this axis, amounts to 0.2-times to 2.0-times the diameter D of the flow channel at the nozzle intake.
Advantageous flow conditions are particularly achieved with a nozzle, in which the flow channel extends in an arched fashion in a segment with reniform cross sections.
The nozzle may be designed in such a way that the flow channel extends linear along an intake section that follows the first end.
The inventive concept likewise includes a nozzle, in which the flow channel extends linear in an end section leading to the second end. In this case, the flow channel may on the second end have an identical cross section over a certain length in the flow direction of the mass with pairs of parallel walls in order to generate a defined fan jet for said mass.
The specific cross sections and cross-sectional areas can be empirically adjusted depending on the type and quantity of the mass. This also applies to the specific geometric features along the flow channel. For example, this includes a nozzle, in which the slot-like cross section of the flow channel at the second end has a height that amounts to 0.7-times to 0.1-times the diameter of the circular cross section at the first end. The slot width is accordingly greater than the diameter of the flow channel on the first end, for example 2 to 10-times greater than the diameter of the circular cross section on the first end.
A distinctive change from a round cross section (at the intake of the nozzle) to a nearly flat cross section (at the outlet of the nozzle) should be achieved. The slot-like second end makes it possible to spray the mass in the form of a flat curtain (fan jet).
The nozzle may be made of any materials; the selection of the specific material particularly depends on the abrasiveness of the mass. Suitable materials are inorganic materials of the group comprising: earthenware, stoneware, porcelain, corundum, metal carbide, metal nitride, steel and plastic.

Other characteristics of the invention can be derived from the sub-claims as well as the other application documents.

The invention is described in greater detail below. To this end, two exemplary embodiments are illustrated in the drawings, wherein

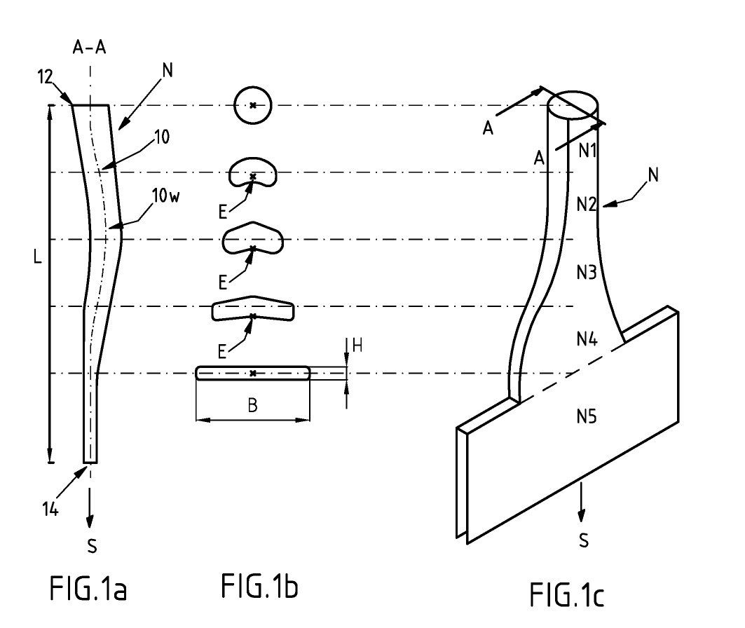

FIG. 1a shows a side view of a first embodiment of a nozzle,

FIG. 1b shows cross sections through the flow channel of the nozzle according to FIG. 1a at corresponding locations (broken lines) indicated in FIG. 1a,

FIG. 1c shows a perspective view of the nozzle according to FIG. 1a,

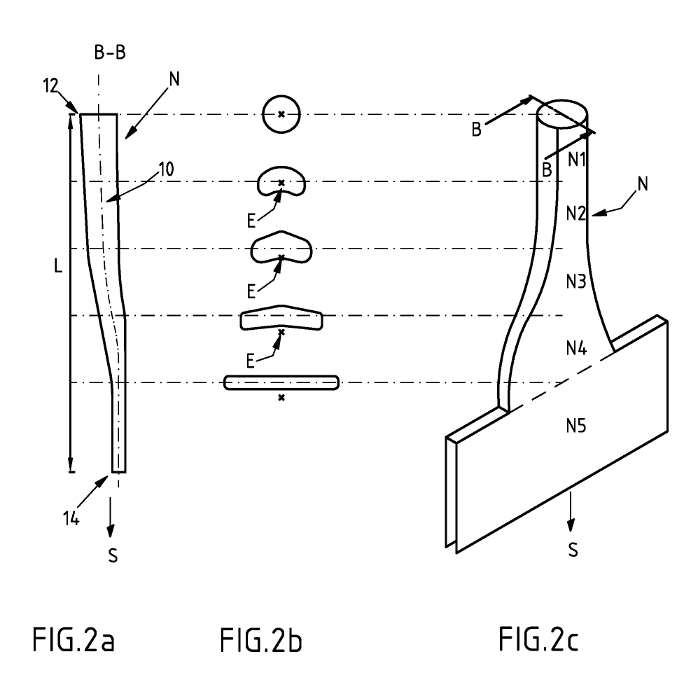

FIG. 2a shows a side view of a second embodiment of a nozzle,

FIG. 2b shows cross sections through the flow channel of the nozzle according to FIG. 1a at corresponding locations (broken lines) indicated in FIG. 2a, and

FIG. 2c shows a perspective view of the nozzle according to FIG. 2a.

FIG. 1 shows a first embodiment of an inventive nozzle for atomizing a refractory inorganic mass.

The nozzle (generally identified by the reference symbol N) features a flow channel 10 that is schematically illustrated in the form of a dot-dash line in FIG. 1a and extends from a first end 12 of the nozzle N to a second end 14 of the nozzle N.

Along the flow direction of the nozzle N the flow channel therefore essentially has five zones N1, N2, N3, N4, N5, which are indicated by horizontally extending lines in FIG. 1c.

In this case, the flow channel 10 has the following cross sections in the zones N1-N5 (respectively referred to the flow direction of the mass to be sprayed—arrow S):

N1: a circular cross section on the first end 12 as illustrated in FIG. 1b; the round cross section transforms into an oval cross section shortly before the beginning of zone N2 and into a reniform cross section with an indentation E (a convex surface section) on one side (bottom of FIG. 1b) at the transition to N2;
N2: the reniform cross section continues, but becomes increasingly thinner and wider; it can be gathered that the curvature radius of the concave (upper) segment of the flow channel cross section increases in zone N2;
N3: the reniform cross section continues, but becomes even thinner and wider; the reniform cross section is furthermore characterized by a convex segment (bottom) and a concave segment (top) with relatively large curvature radius;
N4: the cross section already changes from a distinct reniform cross section toward a slot-like cross section shortly before the transition to N4, wherein the indentation E only marginally (slightly) protrudes inwardly at this point and almost entirely disappears at the transition to N5;
N5: shortly after the beginning of N5, the cross section is exactly rectangular and the flow channel therefore has the shape of a slot at this point, wherein the ratio of width (B) to height (H) amounts to 8:1 and opposing wall surfaces of the flow channel extend parallel to one another. The flow channel 10 therefore has the shape of a slot with a rectangular cross section on the second end.

The axial length of each of the zones N1-N5 amounts to approximately 20% in this case.

Three different reniform cross sections, which are respectively characterized by an indentation E, are illustrated in an exemplary fashion in FIG. 1b.

FIG. 1a, in particular, shows that the flow channel 10 does not extend linear, but rather features an arched segment, which is identified by the reference symbol 10w and particularly extends over the zones N2 and N3, approximately in the center between the first end 12 and the second end 14 of the nozzle N.

The flow channel 12 has a reniform cross section in this segment 10w (see FIG. 1b).

All in all, the flow channel 10 extends in such a way that an axis extending perpendicular to the circular cross section of the first end 12 and through its center of area is vertically offset with respect to the reniform cross sections of the flow channel (i.e. spaced apart from the center of area of the majority of reniform cross sections), but once again extends centrally in the slot-shaped channel segment at N5.

In FIG. 1b, the respective intersecting point of this (imaginary) axis is indicated with “x.”

A refractory ceramic mass which is to be sprayed and which is introduced into the nozzle N at 12, is transported through the flow channel 10 and in the segments with reniform cross section it is at least partially deflected outwardly (due to the respective indentation E) in order to be ejected from the second end 14 in the form of a compact fan jet.

The embodiment according to FIG. 2 is similar to the embodiment according to FIG. 1 such that only the differences between the two embodiments are described below:

In this embodiment, the second end 14 is offset to the first end 12, i.e. an axis extending perpendicular to the circular cross section of the first end 12 and through its center (=center of area) lies outside the slot-like cross section of the flow channel 10 of the second end 14 (in segments N4 and N5), wherein this is once again indicated with “x” in FIG. 2b analogous to FIG. 1.

The lateral offset of the flow channel is realized such that the aforementioned axis is already spaced apart from the flow channel 10 shortly before the slot-shaped end section (i.e. in the zone N4).

In both embodiments, the mass to be sprayed is additionally mixed and homogenized due to the axial extent of the flow channel 10 with an arched segment 10w such that an optimized spraying result is achieved.

Since the mass to be sprayed is ejected from the second end 14 of the nozzle N in the form of a fan jet (similar to a curtain), the thusly sprayed wall coating has homogenous and uniform material properties, as well as a largely constant thickness.

1. A nozzle for spraying an inorganic mass with the following characteristics:
a flow channel (10) that extends from
a first end (12) with an essentially circular cross section to
a second end (14) with an essentially slot-like cross section,
the respective minimal cross section of the flow channel (10) changes from a circular to a reniform and ultimately to a slot-like cross section between the first end (12) and the second end (14), wherein
each reniform cross section features at least one concavely and one convexly curved circumferential segment.

2. The nozzle according to claim 1, in which the flow channel extends between the first end (12) and the second end (14) in such a way that an axis (x) extending perpendicular to the circular cross section at the first end (12) and through its center of area, is spaced apart from the center of area of at least 30% of the reniform cross sections of the flow channel (10).

3. The nozzle according to claim 1, in which the cross section of the flow channel (10) at the second end (14) is no more than 20% smaller than the cross section of the flow channel (10) at the first end (12).

4. The nozzle according to claim 2, in which the axis (x) extending perpendicular to the circular cross section at the first end (12) and through its center of area, also extends through the center of area of the slot-like cross section of the flow channel (10) at the second end (14).

5. The nozzle according to claim 2, in which the axis (x) extending perpendicular to the circular cross section at the first end (12) and through its center of area, lies outside the slot-like cross section of the flow channel (10) at the second end (14).

6. The nozzle according to claim 1, in which the flow channel (10) extends in an arched fashion at least along one segment (10w) between the first end (12) and the second end (14).

7. The nozzle according to claim 1, in which the flow channel (10) extends in an arched fashion in a segment (10w) with reniform cross sections.

8. The nozzle according to claim 1, in which the flow channel (10) extends linear in an intake section that follows the first end (12).

9. The nozzle according to claim 1, in which the flow channel (10) extends linear in an end section leading to the second end (14).

10. The nozzle according to claim 1, in which the slot-like cross section of the flow channel at the second end (14) has a height (H) that amounts to 0.7-times to 0.1-times the diameter (D) of the circular cross section at the first end (12).

11. The nozzle according to claim 1, in which the reniform cross sections respectively feature just one concave, inwardly curved circumferential segment.

12. The nozzle according to claim 1, in which the concave and convex circumferential segments of the reniform cross sections of the flow channel (10) respectively extend over an angle of 30 degrees referred to the center of area of the respective reniform cross section.

13. The nozzle according to claim 1, in which the convex circumferential segments of the reniform cross sections of the flow channel (10) respectively extend over an angle of more than 210 degrees referred to the center of area of the respective reniform cross section.

14. The nozzle according to claim 1, in which the reniform cross sections of the flow channel (10) respectively feature a circumferential segment, the average curvature radius of which is smaller than twice the diameter of the circular cross section at the first end (12) of the flow channel (10).

15. The nozzle according to claim 1, which is made of at least one inorganic material of the group comprising: earthenware, stoneware, porcelain, corundum, metal carbide and metal nitride
